(19) United States
(12) Patent Application Publication
(10) Pub. No.: US 2005/0082458 A1
(43) Pub. Date: Apr. 21, 2005

(54) Christmas tree stand comprising securing wedges

(76) Inventor: Bernd-Martin Koch, Oberhausen (DE)

Correspondence Address: Robert D Fish;Rutan & Tucker, 611 Anton Blvd, Suite1400, Costa Mesa, CA, 92626, US

(21) Appl. No.: 10/182,325

(22) PCT Filed: Jan. 25, 2001
(86) PCT No.: PCT/DE01/00281

(30) Foreign Application Priority Data
Jan. 28, 2000 (DE) 100037666

(51) Int. Cl. F16M 13/00

(52) U.S. Cl. 248/523

(57) ABSTRACT

The invention relates to a Christmas tree stand with a holding body which surrounds the lower end of the trunk of a Christmas tree and with securing wedges for the trunk which are connected to the holding body via blade wedges.

The invention relates to a Christmas tree stand with a holding body which surrounds the lower end of the trunk of a Christmas tree and with securing wedges for the trunk which are connected to the holding body via blade wedges.

In Christmas tree stands of the type referred to in the introduction, the holding body is in most cases designed as a tube which surrounds the lower end of the trunk of the Christmas tree. In order for it to be possible to fix this lower end in the holding body, radially arranged threaded screws are provided in one version of the Christmas tree stand, which are in most cases designed as wing screws and are screwed against the trunk with their end which is frequently equipped with a disk on the inside. In this way, the trunk can be not only secured but also positioned. In another version, wooden wedges made from pieces of wood are driven between the trunk and the holding body in order to fix the trunk.

In the known Christmas tree stands, the lower end of the trunk usually has to be tapered. In the previously known Christmas tree stands with a positioning device which has flat wooden wedges, it is disadvantageous that the wooden wedges can be used only once and, on each new use of the Christmas tree stand, wooden wedges first have to be provided. Many of the previously known Christmas tree stands form an upwardly open, watertight trough which, like a vase, receives the lower end of the Christmas tree.

A Christmas tree stand is known from U.S. Pat. No. 2,613,899, which, in addition to providing a support for the tree trunk via positioning means acting on the trunk, comprises a water reservoir in the stand foot, into which the lower end of the tree projects.

In the previously known Christmas tree stands, the disadvantage exists, however, that the contact surface between the trunk and the water is relatively small, because only the lower surface of the trunk, at which it was cut off, is available for this.

A considerable improvement of the Christmas tree stands known from the prior art, inter alia from U.S. Pat. No. 2,613,899, is described in EP-A-763340. According to the solution of this specification, the Christmas tree stands known from the prior art are improved by virtue of the insertion of the Christmas tree into the stand being greatly simplified, the parts used being reusable, better centering being achieved and the tree trunk coming into contact with water in an improved way. This is achieved by virtue of the fact that, below the positioning arrangement present in the Christmas tree stand described there, blade wedges protect from the holding body, which are formed by radially inwardly facing edges of triangular bodies which are connected to the holding body and are designed in such a manner that a lower end of the trunk, which is inserted into the holding body, meets the blade wedges and, as the pushing-in of the trunk continues, the blade wedges cut into the lower end of the trunk.

Although, in accordance with EP-A-763340, the use of the positioning arrangement in the form of several wedges and a ring holding these together makes possible simple centering and alignment of the tree, further simplified handling is desirable.

The object of the invention is therefore to provide a Christmas tree stand which is improved in relation to the last-mentioned specification and makes possible simpler handling and better guidance of the trunk in the positioning arrangement.

According to the invention, this is achieved by providing a Christmas tree stand having the features of the main claim. The invention therefore relates to a Christmas tree stand with a holding body which surrounds the lower end of the trunk of a Christmas tree and with securing wedges, which each have a hole, for the trunk, blade wedges projecting from the holding body below the securing wedges, which blade wedges are formed by radially inwardly facing edges of triangular bodies which are connected to the holding body and are designed in such a manner that a lower end of the trunk, which is inserted into the holding body, meets the blade wedges and, as the pushing-in of the trunk continues, the blade wedges cut into the lower end of the trunk, a vertical channel being provided in each blade wedge, and in each case a pin being fixed by one end in the hole in the securing wedge, the other end of the pin being arranged vertically movably in the channel, so that each securing wedge can be displaced between an insertion position, in which the securing wedge is mounted rotatably, and a use position, in which each securing wedge is pressed against the lower end of the trunk.

By fixing the securing wedges via the axis of rotation in the channel, a guide rail for the securing wedge, and the vertical mobility thus ensured, optimum guidance and support of the trunk in the Christmas tree stand is made possible. After insertion of the lower end of the trunk and continued pushing-in of the trunk, the blade wedges cut into the lower end of the trunk.

When the Christmas tree stand is filled with water, reliable access of the water to the lower end of the trunk is made possible and through the lateral cuts into the trunk is facilitated.

In order to secure the trunk in this position, the securing wedges (alternatively called positioning wedges) are raised out of the insertion position with radially outwardly facing securing wedges and pressed against the trunk. By means of light hammer blows on the upwardly facing impact edge of the securing wedge, the latter is driven downwardly along the guide channels located in the lower blade wedges and at the same time cuts into the trunk via that corner of the triangular securing wedges facing the trunk.

Through uniform and, through opposite securing wedges, staggered driving-in of each securing wedge around the trunk, centering, fixing and securing of the trunk is thus achieved at in each case the highest point of a securing wedge. When the securing wedge is driven forward in the direction of the channel in the blade wedge, at the same time a lever force is exerted on the securing wedge via the radially outer edge of the securing wedge when this edge meets the holding body, which force has, in addition to the force acting in the driving direction, a radially acting component which facilitates the cutting of the upper corners of the securing wedge into the trunk.

In a preferred embodiment, that edge of the securing wedge facing the trunk is designed not as a straight edge but as an arcuate edge curved away from the trunk. In this embodiment, it is ensured that the distance between the upper pressure point at the upper end of the securing wedge (cutting-in point on the side facing the trunk) and the lower pressure point on the blade wedge is as great as possible, irrespective of whether thickenings, in the form of remains of branches which have been cut off, natural deformities etc., are present in the lower area of the trunk. The great distance between the holding points for the trunk results in improved stable support, and Christmas trees of different size and of different trunk diameter can thus be secured. Furthermore, the Christmas tree stand can correspondingly be manufactured in different sizes, so that it is also suitable for every size of Christmas tree.

The Christmas tree stand is just as suitable as a Christmas tree stand with a water trough as it is as one in which the trunk remains dry and stands in sand, earth or the like. The removal of the securing wedges is easy; to this end, one or more projections, stops or holes can be provided on the securing wedges, which facilitate levering out, as long as the trunk is still located in the holding body, or which make it possible to knock the securing wedges out at a later stage. A steel hook can be inserted into a hole of the securing wedge, and the securing wedge can then be pulled upward, so that the secure connection is freed.

According to the invention, the securing wedges are triangular and they can bear with the longitudinal edge against the upper edge of the holding body depending on the thickness of the trunk and the driving-in depth, and possibly, when the securing wedge is driven in completely, along an inner wall of the holding body. A securing wedge angle of 10 to 25°, preferably 15°, has proved advantageous. That corner of each securing wedge bearing against the trunk can preferably be designed as a cutting edge or have a sawtooth design and acts in the manner of a claw on the trunk, so that the trunk is, by means of the, preferably at least five, circumferentially spaced securing wedges, connected firmly “in a claw-like manner” and stably to the foot.

According to the invention, blade wedges are provided in the lower end area of the holding body, which are designed similarly to the contact surfaces of the securing wedges and can likewise cut into the trunk. They are arranged on a circular ring and, seen from top to bottom, project to an increasing extent toward the center. They are preferably provided in the same number as the securing wedges. The blade wedges preferably also have cutting edges, so that they too open the trunk and make access of water possible in these places. A vertical guide channel, which serves as a guide for the pin fixed to the securing wedge and by virtue of this allows vertical movement of the securing wedge, is provided in each blade wedge.

Further advantages and features of the invention emerge from the other claims and also from the description below of an illustrative embodiment of the invention which is to be understood as non-limiting and is explained in greater detail with reference to the drawing, in which:

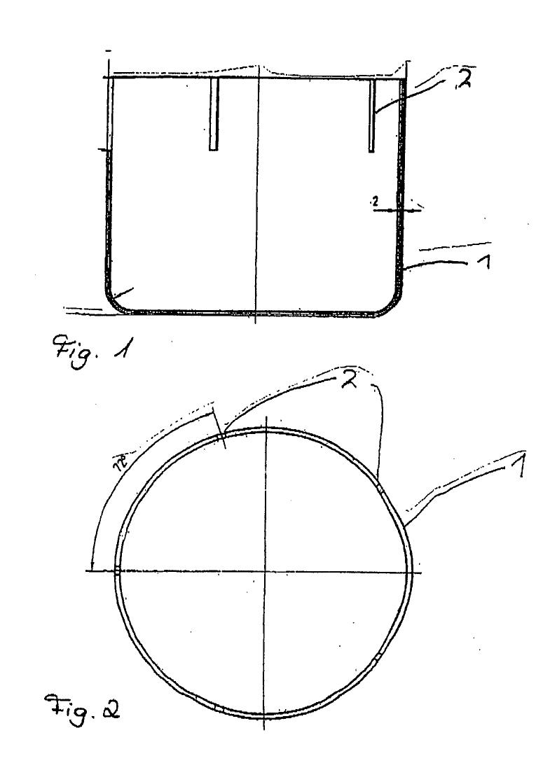

FIG. 1 shows a sectional view of a tubular holding body with channels for the securing wedges;

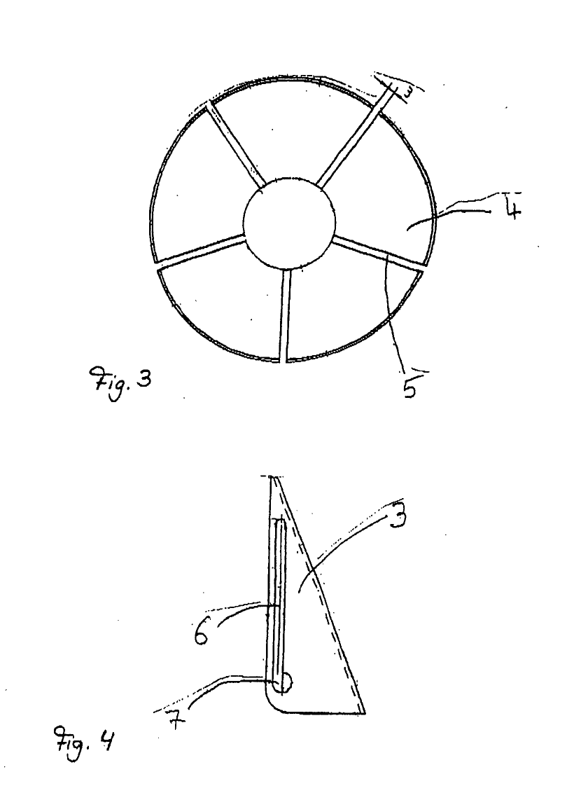

FIG. 2 shows a plan view of the holding body according to FIG. 1 from above;

FIG. 3 shows a plan view of a stabilizing plate for the blade wedges;

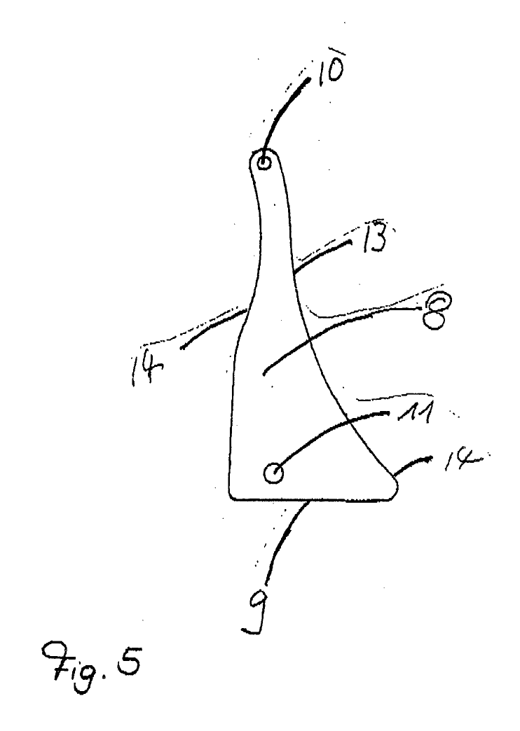

FIG. 4 shows a plan view of a blade wedge;

FIG. 5 shows a plan view of a preferred embodiment of a securing wedge;

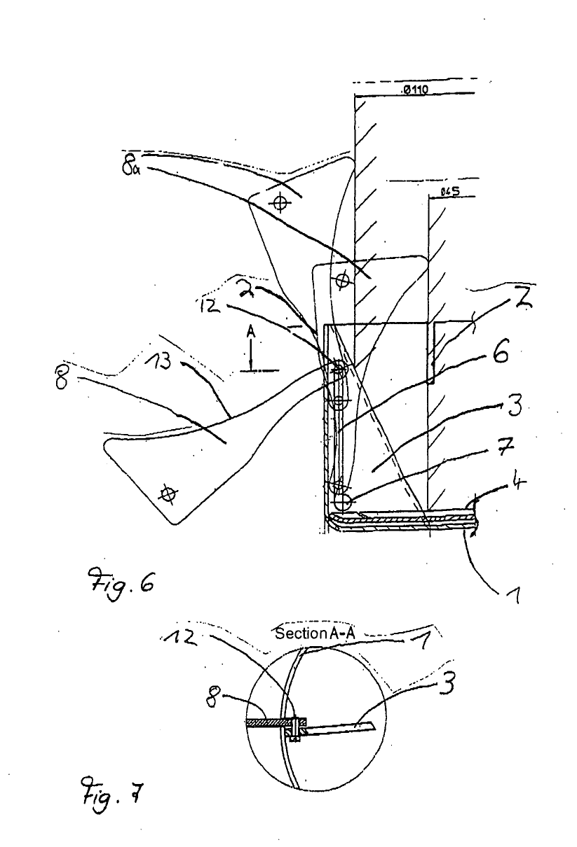

FIG. 6 shows a cross section through the holding body with stabilizing plate, blade wedge and securing wedge, and

FIG. 7 shows a plan view from above of the connection between a blade wedge and a securing wedge.

As can be seen from FIGS. 1 and 2, the Christmas tree stand has a holding body (1) which, here, is in the form of a tubular portion. Attached to this at the bottom is a plate which forms an adequate standing surface. Five blade wedges (3) (not shown in FIGS. 1 and 2), which are arranged directly next to the guide channels (2), project from the inner wall of the tube of the holding body (1). The blade wedges are formed by the radially inwardly facing edges of five triangular bodies which are connected to the tubular holding body (1), and if appropriate also, or only, to the stabilization plate (4), shown in FIG. 3, with the preferably horizontal slots (5) which stabilize the blade wedges.

As can be seen from FIG. 4, the blade wedges (3) run at an angle of roughly 15° to the vertical axis of the Christmas tree stand. They are designed in such a manner that a lower end of a trunk, which is inserted into the tubular holding body (1), meets the blade wedges and, as the pushing-in of the Christmas tree continues, and also under its own weight, they cut into the trunk. Preferably, the blade wedges can be ground on both sides and designed as cutting edges. However, they can also have a sawtooth design. In the latter embodiment, care must be taken that the sawteeth do not hinder too greatly the removal of the trunk when the Christmas tree is taken down. In the illustrative embodiment shown, the diameter at which the blade wedges (3) are located at their uppermost position, where, for instance, they are arranged in the inner diameter of the holding body (1), is two and a half times the diameter of an inner circle at the foot of the five blade wedges, in other words immediately at the plate (4). The blade wedge has a vertical guide channel (6) for the guidance of the securing wedge (8). At the lower end facing the plate (4), the guide channel is enlarged to form a bore (7) which, when the wedge (8) is driven in completely, secures the latter in position on account of the lever force acting thereon.

As shown in FIG. 5, the securing wedge (8) is provided with the impact edge (9), which faces upward in the use position, the bore (10) for the guide pin (12) (not shown in FIG. 5), and a further bore (11) for a hook to be inserted for pulling the wedge out of the use position. The securing wedge has a wedge angle of roughly 15° and two longitudinal sides, namely a curved edge (13) toward the trunk and a bearing edge (14) with which it bears against the holding body (1). As shown in FIG. 5, the bearing edge is, at the end facing the guide pin (12), which can also be in the form of a rivet, preferably curved toward the curved edge (13) like the chord of a circle, so that both thicker and thinner trunks can be pushed into the support better and held securely. The contact surface (13), which is preferably likewise curved like the chord of a circle facing away from the trunk, so that a type of web-like design of the wedge is produced at that end of the wedge facing the bore (10), is preferably ground at least in the area of the wedge corner (14); it can also have sawtoothing. Owing to the configuration of the curves in the form of a wedge, preferably as shown in FIG. 5, no crushing of the trunk in the lower area is brought about, but the trunk is, owing to being guided in the blades fixed to the bottom, clamped (clutched) at the highest point of the wedges.

When a Christmas tree is inserted into the stand according to the invention, the trunk is inserted into the holding body (1) and pushed in from above. In the process, the blade wedges (3), as has been explained above, cut into the wood of the trunk. The trunk is centered in the bottom by means of the funnel-shaped arrangement of the blade wedges (3) and it is secured and centered in this way. When the trunk has been driven sufficiently far into the holding body (1), the fixing and alignment takes place by means of the securing wedges. First, the securing wedges (8), guided in the annular channel between the trunk and the upper edge of the holding body (1), are positioned in such a manner that they bear against the trunk with the wedge corner (14).

The individual securing wedges (8) are then driven into said gap, in the process of which, depending on the diameter of the trunk, they slide along the edge of the guide channel (2) or the inner wall of the holding body (1) and cut into the wood of the trunk. An excellent secure connection is achieved by the penetration into the wood. Depending on the extent to which a securing wedge is driven in, the tree is pressed more to one side, and a vertical alignment is achieved in this way.

It has proved advantageous to provide a number of guide channels (2) in the upper edge area of the holding body (1), in each of which a bearing side of a securing wedge can engage and which cause the securing wedges to be held essentially radially, in other words they cannot slide away laterally.

When the Christmas tree stand according to the invention is removed, the securing wedges (8) can first be pulled up by a suitable hook being hooked into the securing wedge bore provided and pulled upward.

The positioning arrangement has, for example, three to seven, preferably, five or more securing wedges.

The blade wedges (3) on the holding body (1) can in particular be designed as cutting edges or have a sawtooth-shaped design. Preferably three to seven, in particular five, blade wedges (3) are provided. The angle which the blade wedges (3) enclose with the axis of the Christmas tree stand lies in particular between 10 and 25° and is preferably 15°.

FIG. 6 shows a cross-sectional illustration through the Christmas tree stand according to the invention roughly in the center of a guide channel (2) in the holding body (1). In this connection, the securing wedge (8) is shown in the rest position, while the securing wedge with reference number (8a) is illustrated, by a broken line, in the use position, which depends on the diameter of the Christmas tree trunk. Via the pin (12), which, shown from above in cross section in FIG. 7, connects the blade wedge (3) and the securing wedge (8), the securing wedge (8) can be pivoted out of the rest position into the use position and displaced along the guide channel (6) to the catching position in the bore (7). The blade wedges (3) are protected against lateral yielding via the locking plate (4).

1-8. (canceled)

9. A Christmas tree stand comprising:
a holding body that receives a lower end of a trunk of a Christmas tree;
a securing wedge with a guide pin, and a blade wedge having a guide channel, wherein the securing wedge is movably coupled to blade wedge via the guide pin and the guide channel;
wherein the blade wedge is disposed within the holding body, and wherein the securing wedge moves between a first position and a second position when the guide pin moves in the guide channel; and
wherein the securing wedge contacts and secures the trunk of the Christmas tree in the first position and releases the trunk of the Christmas tree in the second position.

10. The Christmas tree stand of claim 9 wherein the securing wedge has an edge proximal to the trunk of the Christmas tree, and wherein the edge curves away from the trunk of the Christmas tree when the securing wedge is in the first position.

11. The Christmas tree stand of claim 9 wherein the holding body has a cylindrical horizontal cross section and a lower end, and wherein the lower end of the holding body is further coupled to a closing plate.

12. The Christmas tree stand of claim 9 wherein the holding body has a lower portion that includes a stabilizing plate for the blade wedge.

13. The Christmas tree stand of claim 9 wherein the holding body further includes a channel that receives the securing wedge.

14. The Christmas tree stand of claim 10 wherein the channel is vertical to the ground when the Christmas tree stand secures a Christmas tree.

15. The Christmas tree stand of claim 9 wherein the securing wedge has an impact surface that forms an angle of less than 90 degrees relative to a vertical axis of the Christmas tree stand.

16. The Christmas tree stand of claim 15 wherein the angle is between 80 degrees and 60 degrees.

17. The Christmas tree stand of claim 9 wherein the securing wedge is a triangular steel plate having a thickness of 3 to 10 millimeter.

18. The Christmas tree stand of claim 17 wherein the securing wedge is a triangular steel plate having a thickness of 3 to 5 millimeter.
